(19) United States
(12) Patent Application Publication
(10) Pub. No.: US 2010/0271517 A1
(43) Pub. Date: Oct. 28, 2010

(54) IN-PIXEL CORRELATED DOUBLE SAMPLING PIXEL

(76) Inventors: Yannick De Wit, Aartselaar (BE); Tom Walschap, Bornem (BE); Bart Cremers, Zonhoven (BE)

Correspondence Address: CYPRESS SEMICONDUCTOR CORPORATION, 198 CHAMPION COURT, SAN JOSE, CA, 95134-1709, US

(21) Appl. No.: 12/766,798

(22) Filed: Apr. 23, 2010

Related U.S. Application Data
(60) Provisional application No. 61/172,370, filed on Apr. 24, 2009.

(51) Int. Cl. H04N 5/335

(52) U.S. Cl. 348/294; 348/E05.091

(57) ABSTRACT

An in-pixel correlated double sampling (CDS) pixel and methods of operating the same are provided. The CDS pixel includes a photodetector to accumulate radiation induced charges, a floating diffusion element electrically coupled to an output of the photodetector through a transfer switch, and. a capacitor-element having an input node electrically coupled to an amplifier and through the amplifier to the floating diffusion element and an output node electrically coupled to an output of the pixel. The capacitor-element is configured to sample a reset value of the floating diffusion element during a reset sampling and to sample a signal value of the floating diffusion element during a signal sampling.

### CROSS-REFERENCE TO RELATED APPLICATIONS

The present application claims the benefit of priority under 35 U.S.C. 119(e) to U.S. Provisional Patent Application Ser. No. 61/172,370 entitled “Pixel With In-Pixel Correlated Double Samplings (CDS) Having Snapshot Ability and Pipelined Single Mode Readout Where That Pixel Only Contains 1 Capacitor and 8 Transistors,” filed Apr. 24, 2009, which application is hereby incorporated by reference in its entirety.

### TECHNICAL FIELD

The present disclosure relates generally to image sensors and more particularly to an in-pixel correlated double sampling pixel and methods of operating the same.

### BACKGROUND

An important design criterion in image sensors is dynamic range, which is defined as a logarithmic ratio between the full scale voltage swing on the photodiode and the smallest detectable variation in photodiode output. Generally, the smallest detectable variation is dominated by reset sampling noise of the photodiode or the floating diffusion depending on which kind of pixel architecture is used (normal photodiode vs. pinned photodiode). Past efforts to reduce the impact of reset sampling noise on dynamic range have relied on correlated double sampling (CDS). CDS is a technique of taking two samples of a signal out of the pixel and subtracting the first from the second to remove reset sampling noise. Generally, the sampling is performed once immediately following reset of the photodiode and once after the photodiode has been allowed to accumulate a charge. The subtraction is performed in peripheral circuitry outside of the pixel or sensor. Conventional CDS pixels include multiple capacitors and transistors or amplifiers inside the pixel reducing a fill factor of the image sensor, and additional complex CDS amplifiers in sensor periphery increasing chip area and design time. Moreover, because two readouts are required before the actual correlated double sampling is performed; the readout speed of the image sensor is greatly reduced.

### SUMMARY

An in-pixel correlated double sampling pixel and method of operating the same are provided. In one embodiment, the pixel includes a photodetector to accumulate radiation induced charges, a floating diffusion element electrically coupled to an output of the photodetector through a transfer switch, and. a capacitor-element having an input node electrically coupled to an amplifier and through the amplifier to the floating diffusion element and an output node electrically coupled to an output of the pixel. The capacitor-element is configured to sample a reset value of the floating diffusion element during a reset sampling and to sample a signal value of the floating diffusion element during a signal sampling.

### BRIEF DESCRIPTION OF THE DRAWINGS

These and various other features of the in-pixel correlated double sampling pixel and methods of operating the same will be apparent upon reading of the following detailed description in conjunction with the accompanying drawings and the appended claims provided below, where:

FIG. 1 is a simplified schematic diagram of a portion of an image sensor including an in-pixel correlated double sampling (CDS) pixel according to one embodiment;

FIG. 2 is a block diagram illustrating a cross-sectional side view of a portion of a CDS pixel showing a floating diffusion region integrally formed in a common substrate with a photodetector and a transfer gate;

FIG. 3 is a simplified schematic diagram illustrating an embodiment of a configuration of the in-pixel CDS pixel of FIG. 1 prior to sampling of the reset value;

FIG. 4 is a simplified schematic diagram illustrating an embodiment of a configuration of the in-pixel CDS pixel of FIG. 1 during/after sampling of the reset value;

FIG. 5 is a simplified schematic diagram illustrating an embodiment of a configuration of the in-pixel CDS pixel of FIG. 1 during/after sampling of the signal value;

FIG. 6 is a timing chart of signals for an embodiment of a method for operating the in-pixel CDS pixel of FIG. 1;

FIG. 7 is a timing chart of signals for a method for operating the in-pixel CDS pixel of FIG. 1 according to another embodiment;

FIG. 8 is a timing chart of signals for a method for operating the in-pixel CDS pixel of FIG. 1 according to another embodiment;

FIG. 9 is a flowchart illustrating an embodiment of a method for operating a CDS pixel to perform in-pixel correlated double sampling:

FIG. 10 is a simplified schematic diagram of a portion of an image sensor including an in-pixel CDS pixel with a calibration switch coupled to a pixel output according to another embodiment;

FIG. 11 is a simplified schematic diagram of a portion of an image sensor including an in-pixel CDS pixel with a precharging transistor coupled to a pixel output according to yet another embodiment; and

FIG. 12 is a timing chart of signals for a method for operating the in-pixel CDS pixel of FIGS. 1 and 11 according to another embodiment to reduce sampling noise from the serial capacitor.

### DETAILED DESCRIPTION

The drawings described are only schematic and are non-limiting. In the drawings, the size of some of the elements may be exaggerated and not drawn to scale for illustrative purposes. The dimensions and the relative dimensions may not correspond to actual reductions to practice of the invention. For purposes of clarity, many of the details of image sensors in general and to image sensors including arrays of active pixels in particular, which are widely known and not relevant to the present control system and method have been omitted from the following description.

The in-pixel correlated double sampling (CDS) pixel described herein is capable of both snapshot shutter and pipelined operations in both single readout mode as well as double sampling readout mode. Snapshot shutter refers to an operation in which substantially every pixel in an array operates at substantially the same time to capture a single frame of data, thereby reducing or eliminating moving artifacts in the captured image. In a pipelined operation, capturing of one frame is accomplished during readout of a previous frame, thereby increasing an effective frame rate of the image sensor. By single readout mode, it is meant that only one sample has to be taken to perform the correlated double sampling.

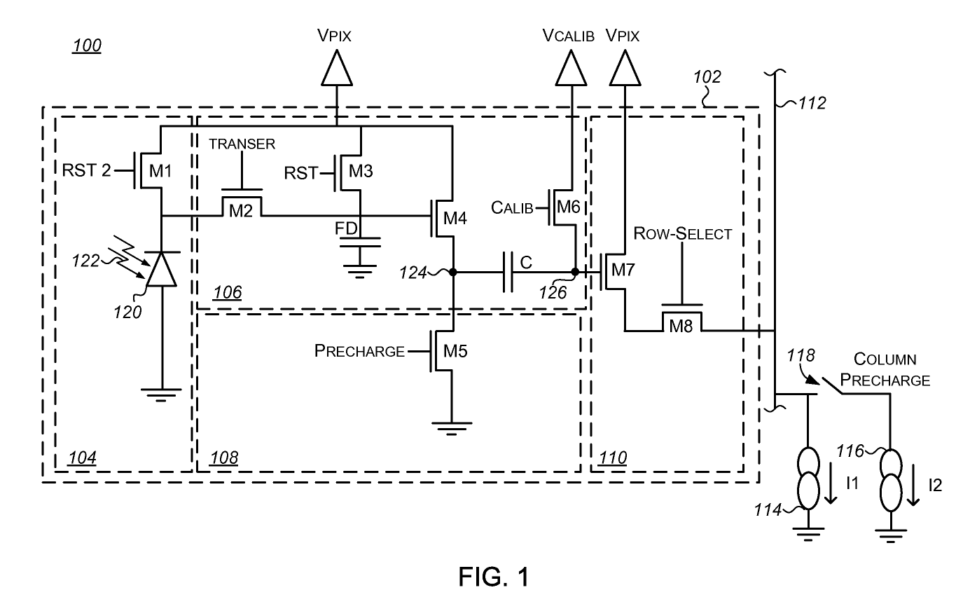

A simplified schematic diagram of a portion of an image sensor 100 including an embodiment of a single, a five transistor (5T) based front end pixel is shown in FIG. 1. Referring to FIG. 1, the in-pixel CDS pixel 102 includes a sensor circuit 104 to generate signals in response to electromagnetic radiation (light); a sample and hold (S/H) stage 106 to read-out or sample and store the signals; a precharge circuit 108 to precharge the serial capacitor; and a buffer/multiplexer circuit 110 to couple an output node of the S/H stage to a pixel output/column 112. The CDS pixel 102 is generally one of multiple pixels in an array of pixels (not shown) arranged in multiple rows and multiple columns, pixel outputs from each column of the multiple rows of pixels coupled to shared column 112 to enable a pipelined or sequential readout of each row of pixels in the array. The array of pixels is formed in a layer of semiconductor material on a common, shared wafer or substrate (not shown), which may include other elements and circuits of the image sensor.

In the embodiment shown, the image sensor 100 further includes a first current supply 114 electrically coupled the column 112 to provide a first current path (I₁), and a second or precharge current supply 116 electrically coupled the column through a column precharge switching-elements of switch 118 to provide a second current path (I₂) to precharge the column.

The sensor circuit 104 includes a photosensor or photodetector 120 to generate a signal in response to electromagnetic radiation 122 (light) received thereon, and a reset switching-element or switch, such as transistor M1. The photodetector 120 can include one or more photodiodes, photogates or charge-coupled devices (CCDs), which generate a change in current, voltage or a charge in response to incident electromagnetic radiation on the photodetector. In the embodiment shown, the photodetector 120 is a reverse-biased pinned photodiode (PD) coupled between ground and a positive pixel voltage supply (V_{PIX}) through transistor M1. When exposed to electromagnetic radiation 122 the semiconductor material of which the photodetector 120 is fabricated photogenerates charge carriers, e.g. electrons, in proportion to the energy of electromagnetic radiation 122 received and to a time or integration period over which the photodetector is exposed to the electromagnetic radiation to accumulate charge on an output node of the photodetector. A reset switching-element (transistor M1), periodically resets the PD 120 to a fixed bias, shown here as V_{PIX}, clearing all accumulated charge on the photodetector at the beginning of every integration period.

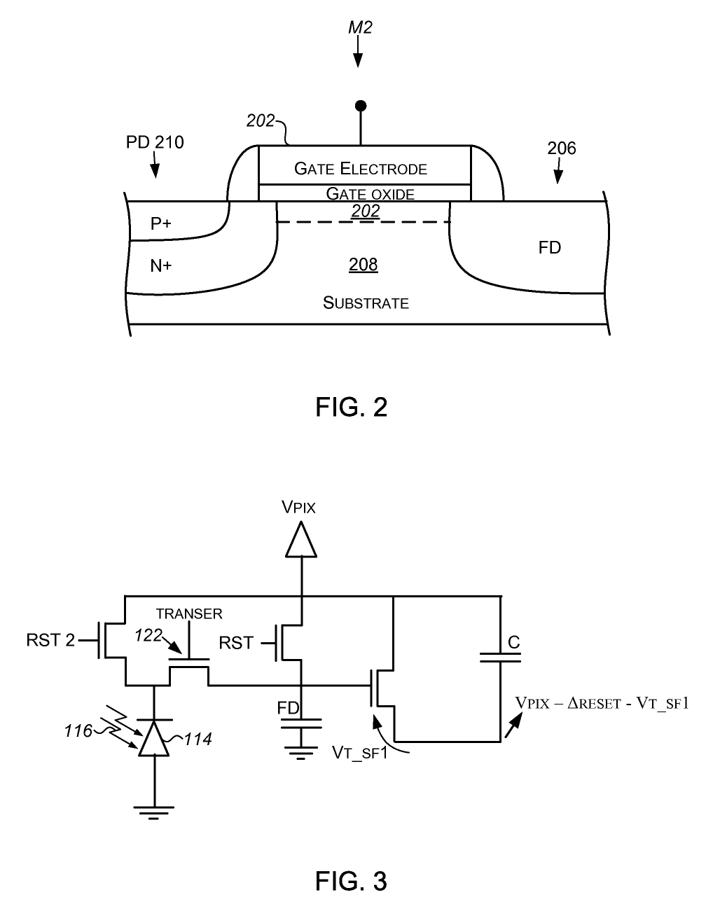

The S/H stage 106 includes a transfer switching-element or switch, such as transistor M2, through which the output node of the photodetector 120 can be electrically coupled to a floating diffusion element, represented schematically in FIG. 1 as capacitor FD. In one embodiment, portions of the sensor circuit 104 and the S/H stage 106 may be formed on and coupled to each other via a common substrate. For example, in the embodiment shown in FIG. 2, the transfer transistor M2 is a complementary metal-oxide-semiconductor (CMOS) transistor including a transfer gate 202 and a channel 204 connecting a floating diffusion element or region 206 integrally formed on or in a common or shared substrate 208 with a pinned, photodiode 210 for the photodetector.

Returning to FIG. 1, the S/H stage 106 further includes a second reset switching-element or switch, transistor M3, through which the floating diffusion element FD is periodically electrically coupled to V_{PIX} to reset the floating diffusion element, and a first amplifier M4 through which floating diffusion element is electrically coupled to a storage element, such as a capacitor-element or capacitor C. In the embodiment shown, the first amplifier M4 is a source follower (SF) amplifier to enable a voltage on the floating diffusion element FD to be sampled without removing the accumulated charge. More specifically, capacitor C is a serial capacitor electrically connected or coupled to the floating diffusion element FD through amplifier M4 to sample and hold or store voltage signals proportional to charge on the floating diffusion element. Capacitor C includes a first or input terminal or node (node 124) coupled to an output of the first amplifier M4, and a second or output terminal or node (node 126) coupled to a readout switching-element or switch in the buffer/multiplexer circuit 110. The second or output node (node 126) of capacitor-element C is further coupled to a calibration switching-element or switch, such as transistor M6, to couple the capacitor to a predetermined, high DC calibration voltage (V_{CALIB}) to enable the capacitor-element to sample a reset value or signal of the floating diffusion element FD following reset of the floating diffusion element.

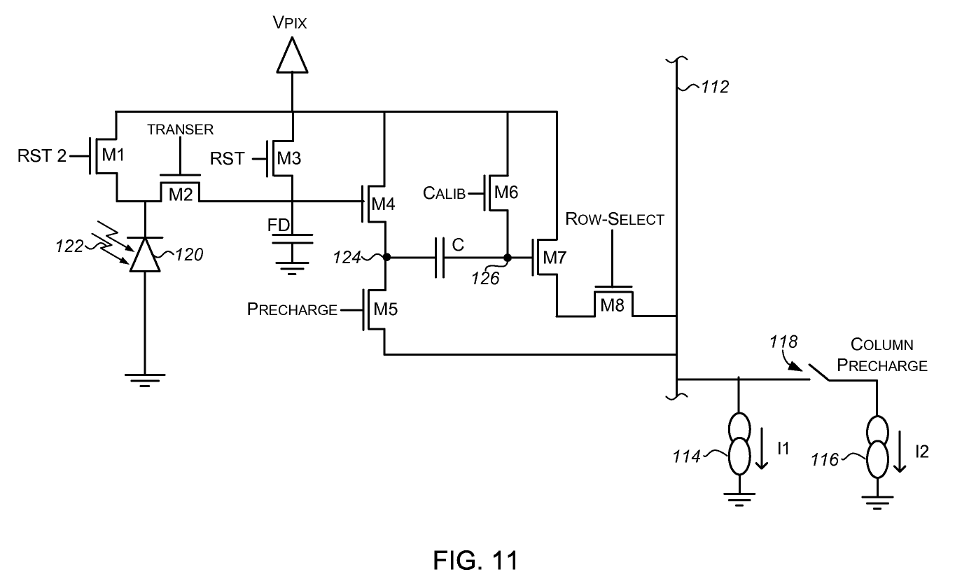

As explained in greater detail below, V_{CALIB} is selected to be within an order of magnitude of the expected reset value to be sure the full swing is maintained during subtraction (sampling). In other embodiments, such as those shown in FIG. 11 and described below, the calibration transistor M6 is coupled to V_{PIX} so that V_{CALIB} is equal to V_{PIX}. However, it will be understood that this need not be the case and that in other embodiments the calibration transistor can instead be coupled to other nodes having another predetermined, high DC voltage (V_{CALIB}).

The precharge circuit 108 includes a precharge or load transistor M5 coupled to capacitor-element C at node 124 to precharge C to a predetermined, precharge voltage prior to sampling the floating diffusion element FD. Precharging is desirable as the first amplifier M4 is a simple source follower (SF) and, if a previous sampled value is higher or within a threshold voltage (V_{T}) of the SF (V_{T}_{_{—}}_{SF1}) of the next sampled value, the SF will cut off and no sampling will take place. Thus, without precharging or clearing the capacitor C the image sensed will rise to a black or blank image over time. Another reason for precharging capacitor C is to help reduce image lag, which is a persistence or incomplete erasure of a previously sampled value, which could lead to errors in imaging.

Although capacitor C generally includes an independent, discrete capacitor, as shown schematically in FIG. 1, alternatively the physical and electrical sizes of capacitor C can be reduced, or a discrete capacitor eliminated entirely, by utilizing intrinsic capacitance formed between a plate of capacitor C coupled to node 124 and an electrical ground of the common substrate (not shown). It will be appreciated, reducing the size of the capacitor C can significantly reduce area in the pixel 102 occupied by non-light sensitive elements, and the pitch or spacing between centers of the pixels, thereby improving fill factors of both the pixel and image sensor 100, as compared to conventional CDS pixels, which typically include three or more discrete capacitors. By fill factor it is meant a ratio of the area of photosensitive elements in the CDS pixel 102 or an array of pixels to a total area of the pixel or array. It will further be appreciated that increasing the fill factor also significantly increases the signal-to-noise (SNR) of the image sensor 100 as the SNR is directly related to the product of fill factor and quantum efficiency.

As noted above, the pixel 102 further includes a multiplexer or buffer/multiplexer circuit 110 to couple an output node of the S/H stage 106 to a pixel output or column 112. In the embodiment shown in FIG. 1 the buffer/multiplexer circuit 110 includes a second source follower (SF) amplifier M7 that acts as a buffer and has a drain connected or coupled to V_{PIX} and a source coupled to the column 112 through a row-select switching-element or switch, such as transistor M8. To read out the CDS pixel, a ROW-SELECT signal is applied to a control node or gate of the row-select transistor M8 causing it to conduct and to transfer a voltage at a source of the second SF amplifier M7 to the column 112.

In the in-pixel CDS pixel 102, the correlated double sampling occurs while transferring the charge from photodetector 120 into the floating diffusion element FD by the circuitry in the back end of the pixel. After this transfer of charge, readout of the image array can start. Note that in the following description all control signals applied to the pixel, i.e., reset, global reset, signals transfer, are global signals, meaning they are applied simultaneously to all pixels of the array, unless noted otherwise.

Details of a CDS operation inside the in-pixel CDS pixel will now be described with reference to FIGS. 3 through 5, which schematically illustrate configurations of the CDS pixel at different times during the CDS operation. Briefly, explanation of the principle of the CDS operation can be divided into two phases: (i) sampling of a floating diffusion element reset value; and (ii) sampling of the floating diffusion element signal value, while subtracting the signal value from the reset value.

### Sampling The Reset Value

Referring to FIG. 3, the floating diffusion element FD is reset by briefly applying a reset signal or pulse to reset transistor M3. After resetting the floating diffusion element FD, the reset value is sampled on capacitor C. During sampling of the reset value, the output node 126 of the capacitor C is connected to a calibration voltage (V_{CALIB}) through calibration transistor M6. As noted above, V_{CALIB} is selected to be within an order of magnitude of the expected reset value (V_{PIX}−ΔVreset), i.e., within a threshold voltage (Vt) of first amplifier M4, to ensure that the SF conducts, therefore in the embodiment shown the capacitor C is connected to V_{PIX}. However, it can be connected to any other node which has a high DC value.

FIG. 3 illustrates the configuration of the CDS pixel during or immediately prior to sampling of the reset value. Referring to FIG. 3, the charges (Q) sampled or stored on capacitor C following sampling of the reset value is as follows:

Qᵣₑₛₑₜ_{_{—}}_{c}=C·((Vpix−ΔVreset−Vt_{—}sf1)−Vpix)=C·(−ΔVreset−Vt_{—}sf1) (Eq. 1)

where C is the capacitance of capacitor C, V_{PIX} is the pixel high voltage, ΔVreset is the decrease in floating diffusion element FD reset voltage due to gate-source crosstalk and KTC noise of the floating diffusion element, and Vt_sf1 is the threshold voltage of the first amplifier M4).

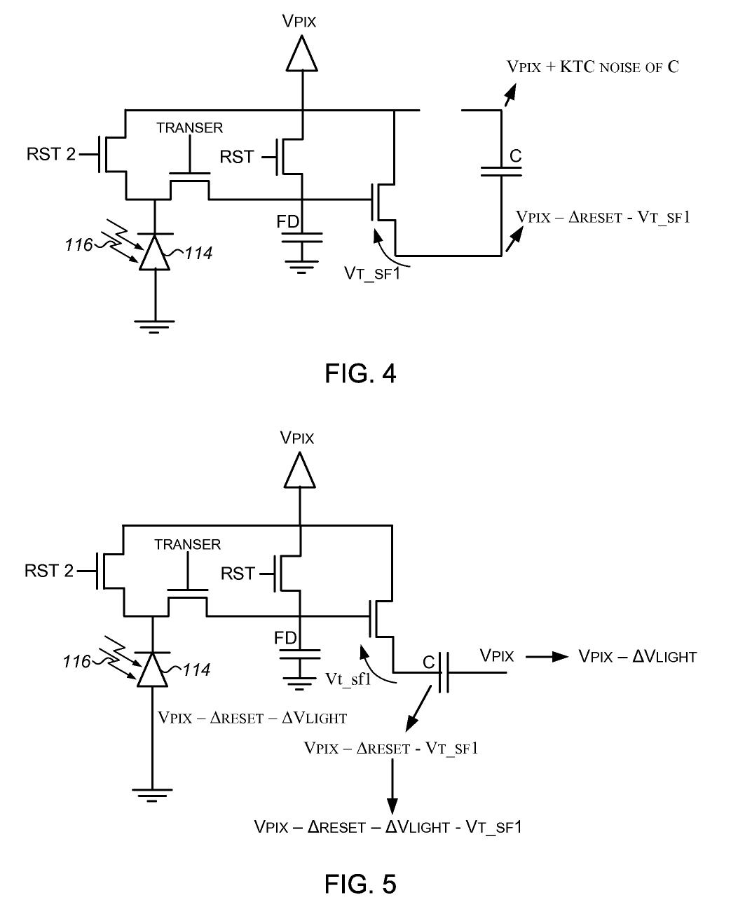

In one embodiment, the sampling of the reset value is accomplished on a trailing edge of the CALIB signal or pulse when the calibration transistor M6 is going off or opening. FIG. 4 illustrates the configuration of the calibration transistor M6 is going off or opening (sampling of the reset value). Referring to FIGS. 1 and 4, When the calibration transistor M6 is going off or opening there is KTC noise on the output node 126 of capacitor C depends on the capacitance of the photodetector 120, which is expressed in the voltage domain as shown in the following equation:

$${V}_{noise\_rms \_C \_outputnode} = \sqrt{\frac{K \cdot T}{C}} \qquad ( Eq . 2 )$$

where K is Boltzmann's constant (˜1.38e-23) in joules per Kelvin, T is the capacitor C's absolute temperature in degrees Kelvin, and C is the capacitance of the capacitor C.

As this KTC noise, will not be subtracted or cancelled out, it is desirable that the capacitance of capacitor C is significantly larger than that of the floating diffusion element FD. By significantly larger it is meant on the order of from about 5 to about >10 times the capacitance of the floating diffusion element FD, or from about 15 to about >40 femtofarads (fF).

### Sampling of The Signal Value

Referring to FIG. 5, after sampling the reset value of the floating diffusion element FD on the serial capacitor C, the circuit of FIG. 1 is configured to sample the signal value by operating transfer transistor M2 to conduct for a predetermined period to transfer charge accumulated on the photodetector to the floating diffusion element FD. The reset voltage of the floating diffusion will now drop to a new voltage depending on the total charge accumulated in the photodiode and the size of the floating diffusion capacitance. This drop in voltage is the signal value that is subsequently subtracted from the reset value to provide true CDS operation. This subtraction occurs during signal sampling, after transferring photodiode charge into floating diffusion.

FIG. 5 illustrates the configuration of the CDS pixel during sampling of the signal value. Referring to FIG. 5, the charges (Q) sampled or stored on capacitor C following sampling of the signal value is as follows:

Q_{signal}_{_{—}}_{c}=C·((Vpix−ΔVreset—ΔVlight−Vt_{—}sf1)−Vy) (Eq. 3)

where C is the capacitance of capacitor C, V_{PIX} is the pixel high voltage, ΔVreset is the decrease in floating diffusion element reset voltage due to gate-source crosstalk and KTC noise of the floating diffusion element, and Vt_sf1 is the threshold voltage of the first SF amplifier M4, ΔVlight is the decrease in floating diffusion element FD voltage following transfer after integration due to light incident on the photodetector, and Vy is the output voltage at node 126 of the S/H stage 106.

Moreover, due to the principal of conservation of charge Qreset_C=Qsignal_C, thus:

C·(−ΔVreset−Vt_{—}sf1)=C·((Vpix−ΔVreset−ΔVlight−Vt_{—}sf1)−Vy) (Eq. 4)

This reduces to:

Vy=Vpix−ΔVlight (Eq. 5)

It is noted that the output voltage of the S/H stage 106 depends solely on the change in voltage due to light and the calibration voltage coupled to node 126 V_{PIX} in the example described above. Thus, the reset variations (reset) due to KTC noise of the PD and fixed pattern noise (FPN) of the first SF amplifier M4 are cancelled out.

After the signal value has been sampled and the subtraction performed, a ROW-SELECT signal or pulse is applied briefly to the gate of the row-select transistor M8, which closes to couple the output of second SF amplifier M7 and transfer the voltage at a source of the second SF amplifier M7 to the column 112. Finally, it is noted that the CDS pixel 102 output value on the column 112 will be lower due to a threshold voltage (V_{T}) of the second SF amplifier M7, so the output value on the column will be:

Vcolumn=Vpix−ΔVlight−Vt_{—}sf2 (Eq. 6)

where Vcolumn is the output value on the column 112, V_{PIX} is the pixel high voltage, ΔVlight the decrease in floating diffusion element FD voltage following integration due to light incident on the photodetector, and Vt_sf2 is the threshold voltage of the second SF amplifier M7.

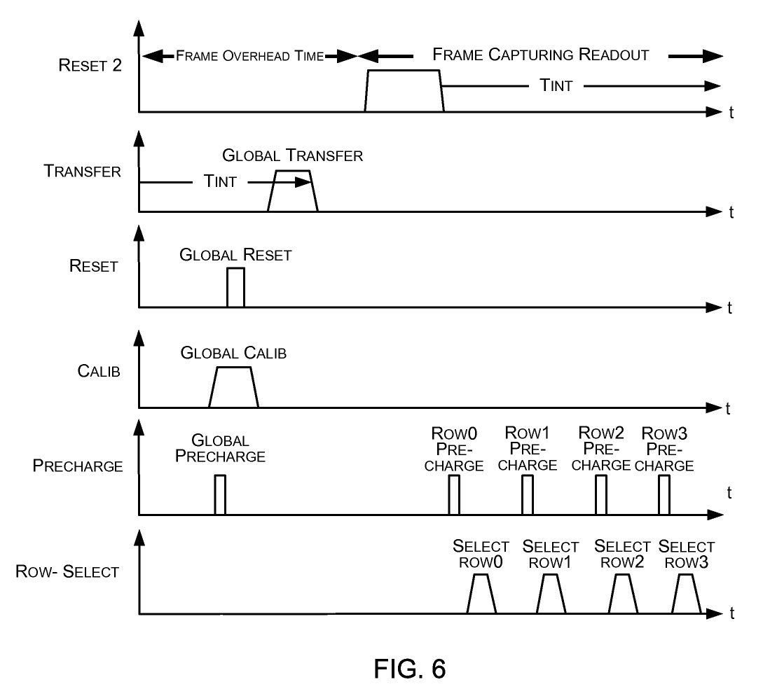

Three possible timing schemes for pipelined operation of the in-pixel CDS pixel of FIG. 1 are illustrated in FIGS. 6 through 8. In a number of the preceding embodiments, the precharge transistor M5 is used as a current source for transistor M4 and not as a switch. Practically, this means the precharge Vgs (gate to source voltage) will be in the order of a threshold voltage (Vt) or about 0.7VDC, and not a positive drain supply voltage (V_{DD}) or about 3.3VDC. This is because when precharging a complete array, the total current cannot be too large because the resulting IR drop on V_{PIX} could cause malfunctioning of the image sensor 100.

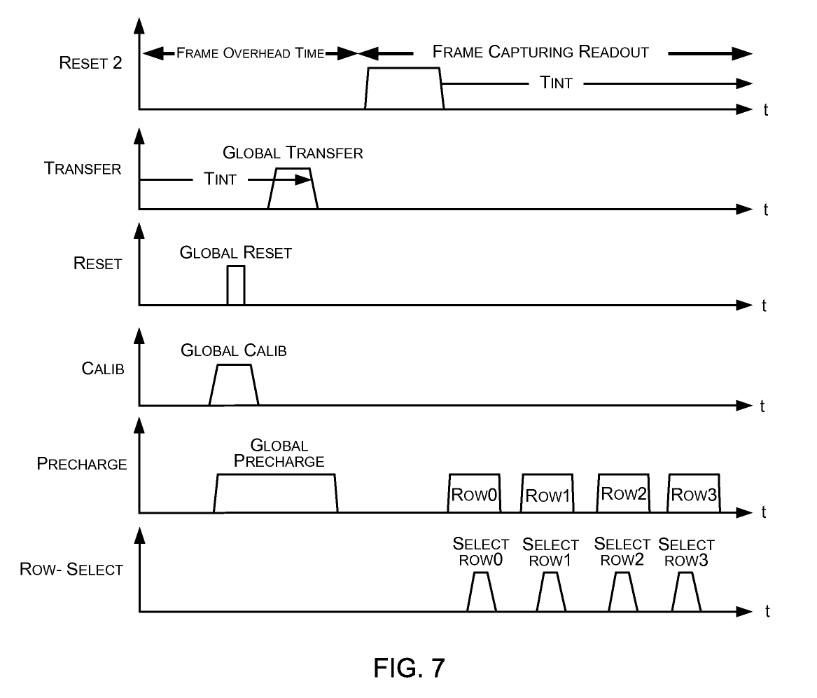

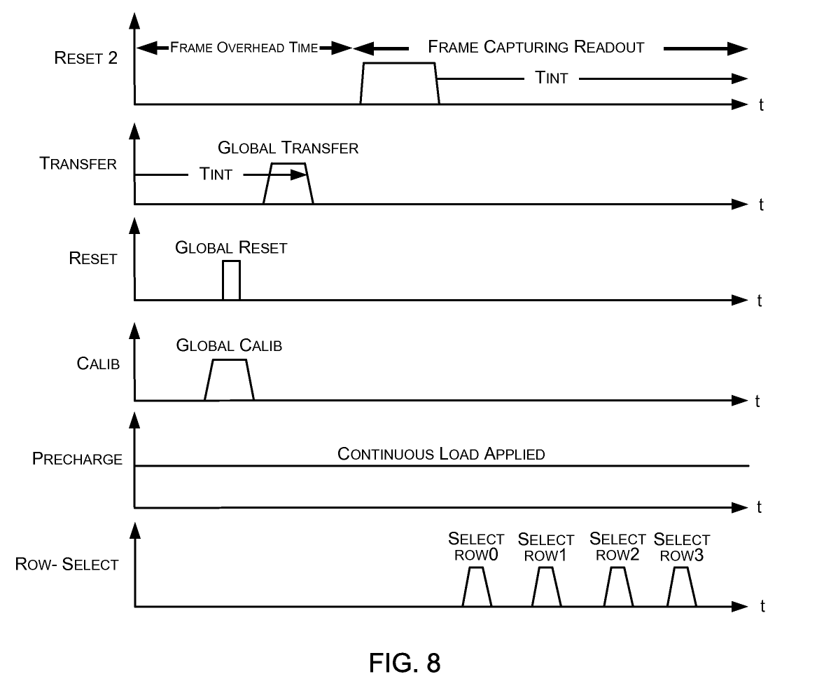

In FIG. 6, precharging of the serial capacitor occurs before sampling of the reset value and the signal value. In FIG. 7, the precharging occurs during sampling of the reset value and the signal value. In the latter case, the precharge transistor M5 is not used as a precharging transistor, but as a load for the first SF amplifier M4. In FIG. 8, the precharge transistor M5 is always on and acts as a continuous load for the first SF amplifier M4. This mode provides the best noise performance, but will have higher power consumption.

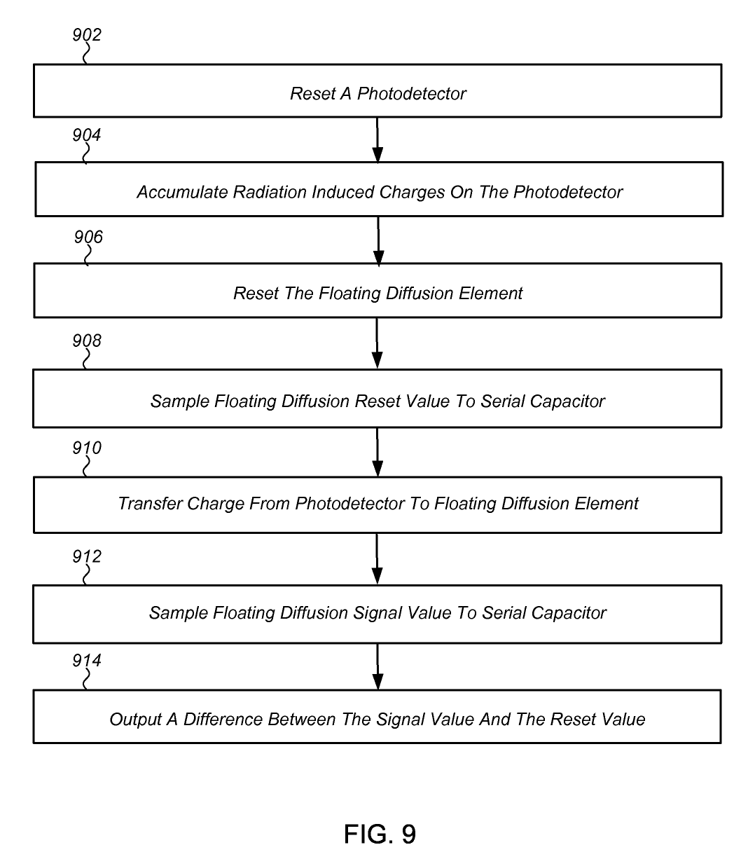

An embodiment of a method for operating a CDS pixel to perform in-pixel correlated double sampling will now be described with reference to the flowchart of FIG. 9. In a first block, the photodetector is reset to remove any residual, accumulated charge on the photodetector by applying a global reset 2 signal to first reset transistor M1 (902). Next, at the beginning of a first integration period, radiation induced charges are accumulated on the photodetector (904). During the first integration period, while accumulating radiation induced charges on a photodetector, the floating diffusion element FD is reset by applying a global reset signal to second reset transistor M3 (906), and the voltage or charge on the floating diffusion element FD (reset value) is sampled to serial capacitor C through the first SF amplifier M4 (908). The sampling of the reset value is accomplished by applying a global CALIB signal to a calibration transistor M6. Optionally, sampling the reset value may further comprise applying a global PRECHARGE signal to a precharge transistor M5 to serve as a load or current source for the first SF amplifier M4. Next, accumulated charge is transferred from the photodetector to the floating diffusion element FD by applying a global TRANSFER signal to a transfer transistor M2 for a predetermined period (910). The voltage or charge on the floating diffusion element FD (signal value) is sampled to serial capacitor C through the first SF amplifier M4 (912). Finally, a difference between the signal value and the reset value is output from an output of the pixel through a second SF amplifier M7 and row-select transistor M8 by applying a row-select signal to the row-select transistor M8. As explained in detail above, the CDS occurs while transferring the charge from photodetector 120 to the floating diffusion element FD.

Although not shown, it will be understood that a second integration period, in which charge is accumulated on the photodetector can begin at any time following the transferring of charge from the photodetector to the floating diffusion element, including during sampling of the signal value from the floating diffusion element to the serial capacitor. This can be accomplished by resetting the photodetector using first reset transistor M1 after transfer transistor M2 ceases to conduct.

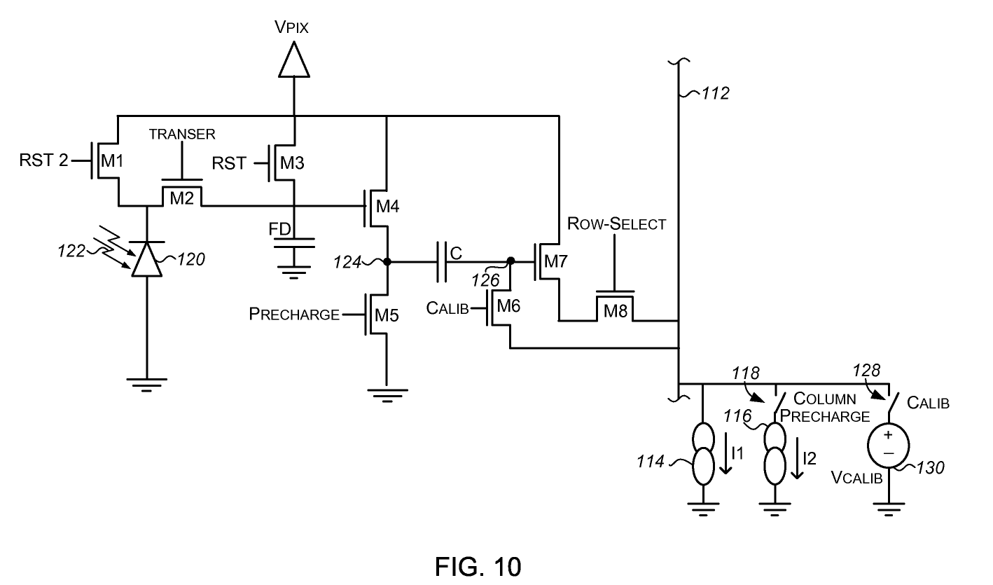

In an alternative embodiment, shown in FIG. 10, the CDS pixel 102 includes a calibration transistor M6 drain is coupled to pixel-output/column 112 or to any column in the array located near the pixel in which it is included. For example, in other embodiments the calibration transistor M6 can be coupled to a column different from that to which the buffer/multiplexer circuit 110 of the pixel 102 is coupled. The other column can include, for example, the column to which an adjacent pixel located in a different column and possibly a different row in the array is coupled. The image sensor 100 further includes a calibration voltage switching-element or switch 128 to couple the column 112 to a predetermined, high DC voltage supply (V_{CALIB} 130) during sampling of the floating diffusion FD reset voltage. It will be appreciated that coupling capacitor C to the column 112 for calibration, rather than to a separate V_{CALIB} tap or line decreases a surface area of the pixel taken up with non-light sensitive elements substantially increasing the fill factor of the pixels and the array, thereby increasing the sensitivity of the image sensor 100.

In another embodiment, shown in FIG. 11, the precharge transistor M5 is coupled to a column precharge current supply (second current supply 116) through the same column 112 to which the buffer/multiplexer circuit 110 is coupled to readout the sampled signal from the pixel 102. Alternatively, the precharge transistor M5 can be coupled to any column in the array located near the pixel in which it is included.

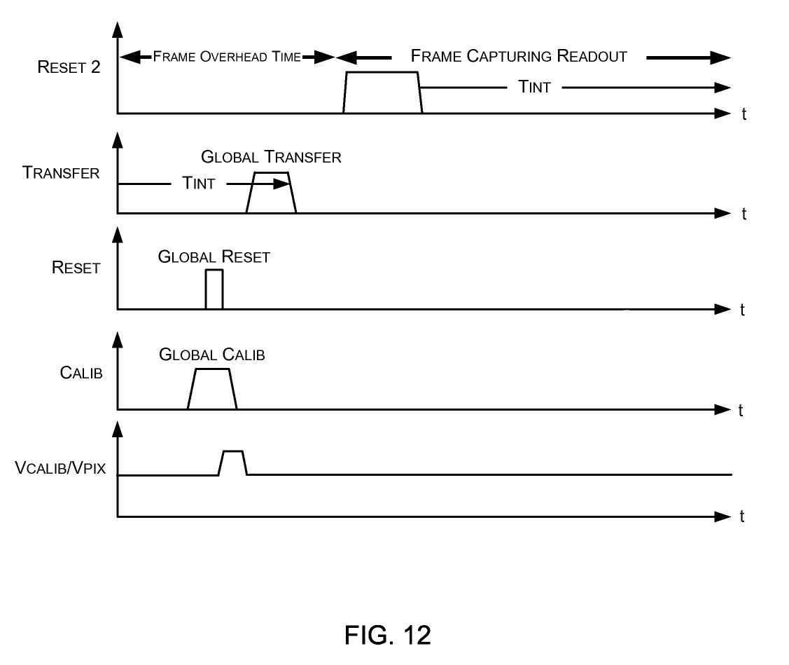

In yet another embodiment, the sampling noise of the capacitor C in the circuits of FIGS. 1 and 11 can be further reduced by applying a soft or hard-soft reset scheme to the calibration transistor M6. Referring to the timing chart of FIG. 12, this can be accomplished by pulsing the VCALIB or VPIX to a higher voltage on a trailing edge of the CALIB signal or pulse so that the voltage set on the right node of capacitor C, output node 126, is set by the gate voltage of M6 and not by VCALIB or VPIX as described in connection with FIGS. 1 and 11 heretofore. This will reduce the sampling noise of capacitor C by at least a square root of 2.

Thus, embodiments of an in-pixel CDS pixel and methods for correlated double sampling of the pixel that increases Dynamic Range and fill factor of the image sensor, while decreasing readout time have been described. Although the present disclosure has been described with reference to specific exemplary embodiments, it will be evident that various modifications and changes may be made to these embodiments without departing from the broader spirit and scope of the disclosure. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

In the forgoing description, for purposes of explanation, numerous specific details have been set forth in order to provide a thorough understanding of the control system and method of the present disclosure. It will be evident however to one skilled in the art that the present interface device and method may be practiced without these specific details. In other instances, well-known structures, and techniques are not shown in detail or are shown in block diagram form in order to avoid unnecessarily obscuring an understanding of this description.

Reference in the description to “one embodiment” or “an embodiment” means that a particular feature, structure, or characteristic described in connection with the embodiment is included in at least one embodiment of the control system or method. The appearances of the phrase “one embodiment” in various places in the specification do not necessarily all refer to the same embodiment. The term “to couple” as used herein may include both to directly electrically connect two or more components or elements and to indirectly connect through one or more intervening components.

What is claimed is:

1. A correlated double sampling (CDS) pixel comprising:
a photodetector to accumulate radiation induced charges;
a floating diffusion element electrically coupled to an output of the photodetector through a transfer switch; and
a capacitor-element having an input node electrically coupled to an amplifier and through the amplifier to the floating diffusion element and an output node electrically coupled to an output of the pixel, the capacitor-element configured to sample a reset value of the floating diffusion element during a reset sampling and to sample a signal value of the floating diffusion element during a signal sampling.

2. A CDS pixel according to claim 1, further comprising a precharge transistor electrically coupled between the input node of the capacitor-element and an electrical potential to precharge the capacitor-element prior to reset sampling.

3. A CDS pixel according to claim 2, wherein the precharge transistor is further configured to as a current source during signal sampling.

4. A CDS pixel according to claim 2, further comprising a calibration switch electrically coupled between the output node of the capacitor-element and a voltage supply (V_{CALIB}) to calibrate the capacitor-element during reset sampling.

5. A CDS pixel according to claim 4, further comprising a first reset switch through which the output of the photodetector is electrically coupled to a pixel voltage supply (V_{PIX}), and a second reset switch through which the floating diffusion element is electrically coupled to V_{PIX}.

6. A CDS pixel according to claim 5, the voltage supply (V_{CALIB}) is the same voltage as the pixel voltage supply (V_{PIX}).

7. A CDS pixel according to claim 4, wherein the output of the pixel comprises a row-select switch to electrically couple the output node of the capacitor-element to one of a number of column outputs in an array of a plurality of CDS pixels, and wherein the calibration switch is electrically coupled between the output node of the capacitor-element and a column output in the array.

8. A CDS pixel according to claim 2, wherein the output of the pixel comprises a row-select switch to electrically couple the output node of the capacitor-element to one of a number of column outputs in an array of a plurality of CDS pixels, and wherein the precharge transistor is electrically coupled between the input node of the capacitor-element and an a column output in the array.

9. A CDS pixel according to claim 1, wherein the transfer switch comprises a transfer gate.

10. A CDS pixel according to claim 9, wherein the floating diffusion element comprises a floating diffusion region integrally formed in a common substrate with the photodetector and the transfer gate

11. A correlated double sampling (CDS) circuit comprising:
a floating diffusion element electrically coupled to an output of a sensor through a transfer switch; and
a capacitor-element having an input node electrically coupled to an amplifier and through the amplifier to the floating diffusion element and an output node electrically coupled to an output of the circuit, the capacitor-element configured to sample a reset value of the floating diffusion element during a reset sampling and to sample a signal value of the floating diffusion element during a signal sampling;
a precharge transistor electrically coupled between the input node of the capacitor-element and an electrical potential to precharge the capacitor-element prior to reset sampling; and
comprising a calibration switch electrically coupled between the output node of the capacitor-element and a voltage supply (V_{CALIB}) to calibrate the capacitor-element during reset sampling.

12. A CDS circuit according to claim 11, wherein the precharge transistor is further configured to as a current source during signal sampling.

13. A CDS circuit according to claim 11, wherein the transfer switch comprises a transfer gate.

14. A CDS circuit according to claim 13, wherein the floating diffusion element comprises a floating diffusion region integrally formed in a common substrate with the sensor and the transfer gate

15. A method for performing correlated double sampling in a pixel, the method comprising:
during a first integration period, accumulating radiation induced charges on a photodetector while resetting a floating diffusion element, calibrating a capacitor-element and sampling a reset value of floating diffusion element to an input node of the capacitor-element; and
following the first integration period, transferring charge from the photodetector to the floating diffusion element and sampling a signal value of the floating diffusion to the input node of the capacitor-element, while a difference between the signal value and the reset value is output on an output node of the capacitor-element.

16. A method according to claim 15, wherein the pixel further comprises a precharge transistor electrically coupled between the input node of the capacitor-element and an electrical potential, and further comprising precharging the capacitor-element prior to sampling the reset value.

17. A method according to claim 16, wherein the pixel further comprises an amplifier through which the floating diffusion element is electrically coupled to the input node of the capacitor-element, and further comprising operating the precharge transistor as a current source for the amplifier during sampling of the signal value.

18. A method according to claim 16, wherein the pixel is one in an array of a plurality of pixels in an image sensor, and further comprising reading out from the output node of the capacitor-element to a column in the array a final pixel value comprising the difference between the signal value and the reset value.

19. A method according to claim 18, further comprising operating the image sensor in a snapshot mode in which the final pixel values of the plurality of pixels result from radiation induced charges accumulated during the same first integration period.

20. A method according to claim 19, further comprising operating the image sensor in a pipelined readout mode in which during readout of the final pixel values resulting from radiation induced charges accumulated during the first integration period, radiation induced charges are accumulated on the photodetector during a second integration period.
